(19) United States
(12) Patent Application Publication
(10) Pub. No.: US 2009/0272727 A1
(43) Pub. Date: Nov. 5, 2009

(54) PTC heating device with cathode oxygen depletion function for fuel cell vehicle

(75) Inventor: Su Dong Han, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 12/229,182

(22) Filed: Aug. 19, 2008

(30) Foreign Application Priority Data
Apr. 30, 2008 (KR) 10-2008-0040374

(51) Int. Cl. B60L 1/02

(52) U.S. Cl. 219/205; 903/902

(57) ABSTRACT

The present invention provides a positive temperature coefficient (PTC) heating device with a cathode oxygen depletion (COD) function for a fuel cell vehicle, which can improve durability of a fuel cell stack by reacting residual oxygen with hydrogen to be consumed as heat and improve cold startability by rapidly heating a coolant even at a temperature below the freezing point, the PTC heating device including a housing having an inlet and an outlet, formed on both ends there of, and a PTC heater fixed in the inside of the housing and including an electrode to which electric power is applied from the outside, a PTC heating element disposed on the electrode, and an insulating tape for insulating the PTC heater from a coolant flowing in the housing. Accordingly, it is possible to improve electrical safety and heat transfer performance and effectively prevent bubbles from forming, compared with a conventional cartridge heater.

Moreover, the present invention provides the PTC heating device which includes at least one radiating plate including a plurality of radiating fins having concave and convex. Furthermore, the PTC heating element included in the PTC heater is inserted between two electrodes and the insulating tape is arranged on the surfaces of both sides of the electrodes. As a result, it is possible to improve heat transfer efficiency.

In addition, the present invention provides the PTC heating device, in which a PWM control system is provided on the outside of the housing to control a heating current, thus facilitating the control of the surface temperature.

### CROSS-REFERENCE TO RELATED APPLICATION

This application claims under 35 U.S.C. §119(a) the benefit of Korean Patent Application No. 10-2008-0040374 filed Apr. 30, 2008, the entire contents of which are incorporated herein by reference.

### BACKGROUND

(a) Technical Field

The present invention relates to a thermal management system (TMS) used in a fuel cell vehicle. More particularly, the present invention relates to a positive temperature coefficient (PTC) heating device with a cathode oxygen depletion (COD) function for a fuel cell vehicle, which can rapidly heat a coolant for a fuel cell stack.

(b) Background Art

Automobile companies have developed hydrogen fuel cell vehicles in an effort to develop environmentally-friendly vehicles. Hydrogen fuel cell vehicles developed to date may be improved in their cold startability.

One method to improve the cold startability of a conventional fuel cell vehicle is a rapid thawing of pure water using a heater provided in a rapid thaw accumulator (RTA).

However, in examples where pure water is used, considerations include that the pure water is frozen at a temperature below the freezing point, and thus a coolant loop is complicated, and preferably a drain valve should additionally be provided.

In certain cases, a method is proposed in which an antifreeze solution for a fuel cell stack is used as a coolant and the coolant is rapidly heated to improve the power generation efficiency of the fuel cell stack at a temperature below the freezing point.

According to this method, it is necessary to attach the heater to a coolant line of the fuel cell stack. Moreover, in order to prevent deterioration of durability of the fuel cell stack due to corrosion of catalyst-loaded carbon during start-up and shut-down of the fuel cell vehicle, a cathode oxygen depletion (COD) is connected to both terminals of the fuel cell stack so that the electrical energy generated by a reaction between hydrogen and oxygen is consumed to generate heat energy.

The conventional cathode oxygen depletion is connected to both terminals of the fuel cell stack such that a cathode oxygen depletion for start-up or a cathode oxygen depletion for state-down converts residual oxygen in the fuel cell stack into heat by reacting with hydrogen, thus removing the residual oxygen in the fuel cell stack However, conventionally, there has been no heater developed for heating the coolant for the fuel cell stack only to improve the power generation efficiency of the fuel cell stack at a temperature below the freezing point upon start-up of the vehicle. The cathode oxygen depletion is not developed as a heater, but is used as a device for reacting the residual oxygen in the fuel cell stack with hydrogen to be consumed as heat during start-up or start-down of the vehicle, thus ensuring durability of the fuel cell stack.

Thus, it has been required to develop a heating device with a cathode oxygen depletion (COD) function for a fuel cell vehicle, which can rapidly heat the coolant to improve the power generation efficiency of the fuel cell stack at a temperature below the freezing point upon start-up of the vehicle and suitably overcome the conventional devices in which the manufacturing cost is increased and it is difficult to ensure a sufficient layout space in the case where the heater for heating the coolant and the cathode oxygen depletion are separately provided.

The heater and the cathode oxygen depletion may suitably be resistance heaters which can be preferably integrated into a single heater, although their operation time and use are different. Accordingly, the present applicant of the preset invention has disclosed, in Korean Patent Application No. 10-2007-0105369, a heating device with a cathode oxygen depletion (COD) function for a fuel cell vehicle, in which an existing COD function for improving durability of a fuel cell stack and a heater for improving cold startability of the fuel cell vehicle are integrated.

However, the conventional heating device with the COD function in the form of a cartridge, in which a cartridge rod is inserted, is a simple resistance heater, which controls current in a multistage manner via a relay may be overheated by overvoltage, the insulation resistance may be deteriorated due to water vulnerability of an insulating material MgO inside the cartridge heater, and bubbles may be formed on the surface of the heater with a high heating density.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the invention provides an improved PTC heating device with a cathode oxygen deletion function for a fuel cell vehicle, which employs a high voltage PTC heater, in which a caloric value is reduced with a reduction in heating current as a resistance is increased when its internal temperature reaches a certain temperature, so as to improve electrical stability and heat transfer performance and effectively prevent bubbles from forming inside the heater.

In one preferred embodiment, the present invention provides a PTC heating device with a cathode oxygen depletion function for a fuel cell vehicle, the PTC heating device comprising: a housing including an inlet and an outlet, formed on both ends there of; and a PTC heater fixed in the inside of the housing and including an electrode to which electric power is applied from the outside, a PTC heating element disposed on the electrode, and an insulating tape for insulating the PTC heater from a coolant flowing in the housing.

In another preferred embodiment, the PTC heater comprises at least one radiating plate including a plurality of concave and convex radiating fins.

In another preferred embodiment, the PTC heating element included in the PTC heater is preferably inserted between two electrodes and the insulating tape is arranged on the surfaces of both sides of the electrodes.

In still another preferred embodiment, a PWM control system is suitably provided on the outside of the housing to control a heating current.

In yet another preferred embodiment, the housing has a hexagonal cross section in which the width of the cross-sectional area is increased from the inlet to the middle portion, the width of the cross-sectional area is maintained constant in the middle portion, and the width of the cross-sectional area is reduced form the middle portion to the outlet.

In still yet another preferred embodiment, a pair of guide plates is provided at the inlet in the housing to extend toward the inside of the housing.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 is graph showing a change in temperature and resistance of a PTC heating element.

FIG. 2 is a perspective view showing a configuration of a PTC heating device with a COD function for a fuel cell vehicle in accordance with a preferred embodiment of the present invention.

FIGS. 3A and 3B are plan views showing examples of PTC heating elements arranged on the PCT heating device with the COD function for a fuel cell vehicle in accordance with the present invention.

FIGS. 4A to 4C are side views showing examples of the PTC heating elements arranged on the PCT heating device with the COD function for a fuel cell vehicle in accordance with the present invention.

FIG. 5 is a configuration diagram showing a PWM control system for controlling the PCT heating device with the COD function for a fuel cell vehicle in accordance with the present invention.

FIG. 6 is a graph showing a change in heating current by the PWM control system.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes a PTC heating device with a cathode oxygen depletion function for a fuel cell vehicle, the PTC heating device comprising a housing including an inlet and an outlet, formed on both ends there of; and a PTC heater fixed in the inside of the housing. In certain embodiments, the PTC heater fixed in the inside of the housing further includes an electrode to which electric power is applied from the outside and a PTC heating element disposed on the electrode. In other embodiments, the PTC heater fixed in the inside of the housing further includes an insulating tape for insulating the PTC heater from a coolant flowing in the housing. In other further embodiments, the PTC heater comprises at least one radiating plate including a plurality of radiating fins having concave and convex surfaces. In related embodiments, the PTC heating element included in the PTC heater is inserted between two electrodes and the insulating tape is arranged on the surfaces of both sides of the electrodes. In other preferred embodiments, a PWM control system is provided on the outside of the housing to control a heating current.

Also included in the invention is a motor vehicle comprising the PTC heating device as described in any of the aspects herein.

Hereinafter reference will now be made in detail to various embodiments of the present invention, examples of which are illustrated in the accompanying exemplary drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

In one embodiment, the present invention provides a PTC heating device with a cathode oxygen depletion (COD) function for a fuel cell vehicle, which suitably uses a positive temperature coefficient (PTC) element 34 as a heat source which prevents deterioration of a fuel cell stack and improves current generation efficiency of the fuel cell stack by heating a coolant for the fuel cell stack, thus suitably improving cold startability of the fuel cell vehicle.

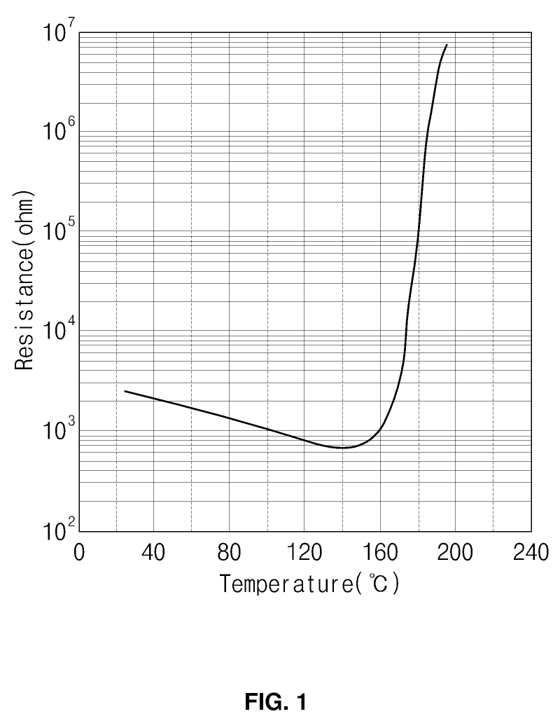

The PTC heating element 34 is a kind of n-type n element oxide semiconductor that obtains conductivity by adding a very small amount of rare earth elements to e.g., BaTiO3. In preferred examples, curie temperature of the n-type oxide semiconductor can be shifted by substituting Sr or Pb for a portion of Ba. The PTC heating element 34 has a resistance that increases suddenly as its internal temperature increases due to a phase transition when its internal temperature reaches a certain temperature. Accordingly, since the heater using a plurality of the PTC heating elements 34 suitably changes the resistance according to its internal temperature, it is possible to perform the temperature control of the heating surface and the current control by itself. That is, it can be seen from the graph of FIG. 1 that the heater using the PTC heating elements 34 can suitably control a desired heating surface temperature value Tc by controlling the composition of a material inside the heater.

In certain embodiments, the PTC heating device with the COD function for a fuel cell vehicle in accordance with the present invention suitably includes a PTC heater 30 using the PTC heating elements 34 preferably having a switching effect so that introduced coolant is heated by the heater to improve the cold startability.

In other embodiments, the PTC heater 30 may preferably be composed of a radiating fin 32, on which an electrode 33 to which electric power is suitably applied and the PTC heating elements 34 generating heat by the applied electric power are formed. Moreover, an insulating tape 35 may be suitably provided on the PTC heating elements 34 to insulate the PTC heating elements 34 from the introduced coolant.

In other preferred embodiments, the PTC heater 30 is preferably provided on a coolant loop, and a suitable housing 10 for introducing and discharging the coolant is disposed on the coolant loop and accommodates the PTC heater 30 therein.

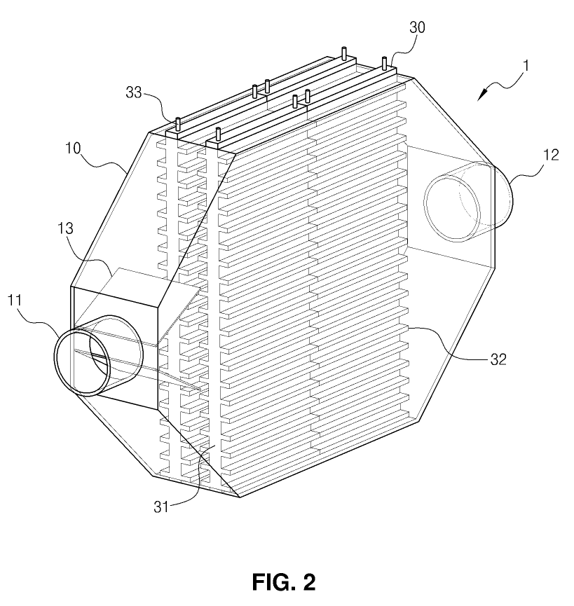

FIG. 2 is a perspective view showing an exemplary configuration of the PTC heating device 1 with the COD function for a fuel cell vehicle in accordance with a preferred embodiment of the present invention.

As shown in FIG. 2, the housing 10 is suitably provided on the coolant flow path. The housing 10 preferably includes an inlet 11 and an outlet 12, provided on both ends thereof, and may have various forms. In other embodiments, in order to appropriately maintain the coolant flow and include a heater having a sufficiently high heating value, the housing 10 may preferably have a hexagonal cross section that has a minimum cross-sectional area at the inlet 11 and the outlet 12 and a maximum cross-sectional area at a predetermined distance in the middle portion thereof. Moreover, a pair of guide plates 13 is preferably provided at the inlet 11 in the housing 10 to suitably extend toward the inside of the housing so that the coolant is uniformly distributed to the inside of the housing 10.

Preferably, in certain examples, the PTC heater 30 preferably including the PTC heating elements 34, in which the temperature of the heating surface is controlled by itself as the resistance value is increased with the increase in the heating temperature, is suitably accommodated in the housing 10. In exemplary embodiments, the PTC heater 30 can prevent overload of the surface due to a sudden increase in resistance even in the event that the coolant is not circulated, and maintain the surface temperature suitably constant, thus preventing damage due to overheating, differently from the conventional cartridge resistance type heater.

In other embodiments, it is preferable that the PTC heater 30 has a suitably sufficient surface area to provide sufficient thermal conduction. As shown in exemplary FIG. 2 the PTC heater 30 may be in the form of a radiating plate 31 including a plurality of radiating fins 32 having concave and convex surfaces. In other embodiments, a plurality of radiating plate 31 may be provided according to the overall heating value and cooling rate.

According to certain embodiments of the invention, the radiating plate 31 preferably includes the electrode 33 so that the PTC heating elements 34 can generate heat by the electric power applied from the outside, and the PTC heating elements 34 are suitably arranged on the electrode 33.

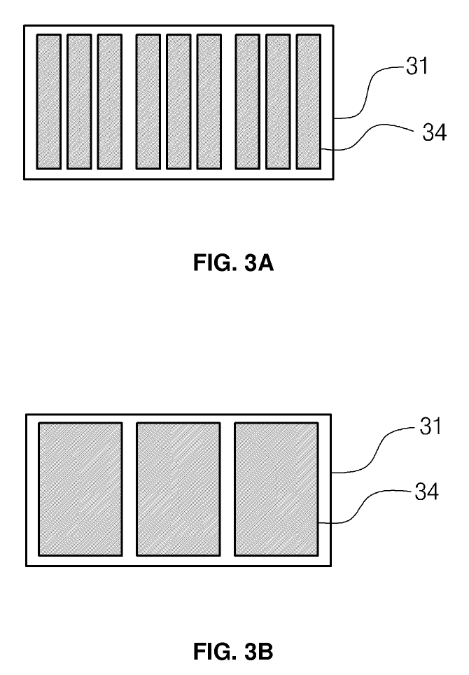

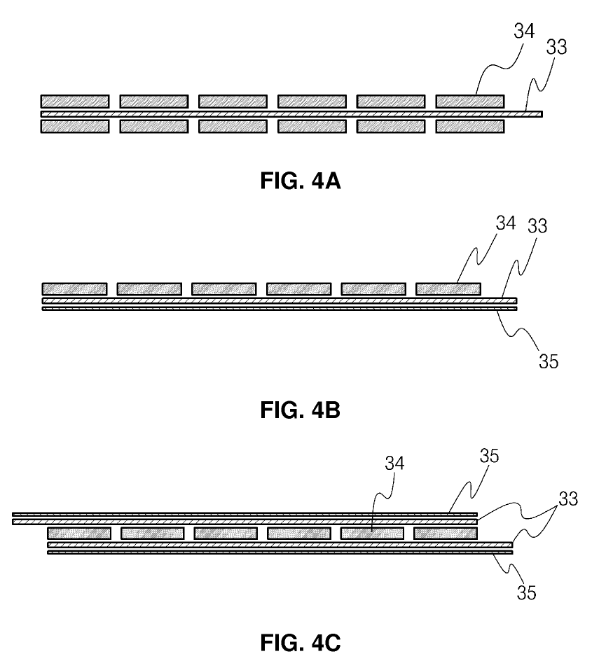

FIGS. 3 and 4 shows examples of the PTC heating elements 34 suitably arranged on the PTC heater 30 of the PTC heating device with the COD function for a fuel cell vehicle in accordance with certain embodiments of the present invention. According to other further embodiments, it is possible to arrange the PTC heating elements 34 in various shapes and sizes other than the examples shown in the figures.

FIGS. 3A and 3B are plan views showing the exemplary arrangements of the PTC heating elements 34 and, as shown in the figures, the PTC heating elements can preferably be arranged on the radiating plate 31 at regular intervals.

FIGS. 4A to 4C are side views showing exemplary arrangements of the PTC heating elements 34. FIG. 4A shows an example in which the PCT elements 34 are suitably arranged on both sides of the electrode 33, FIG. 4B shows an example in which the PTC heating elements 34 are suitably arranged on one side of the electrode 33 and the insulating tape 35 is applied on the other side of the electrode 33, and FIG. 4C shows an example in which the PTC heating elements 34 are suitably disposed between the electrodes 33 and the insulating tape 35 is preferably wound thereon to be insulated from the outside.

In other embodiments, the PTC heater 30 having the structure of FIG. 4C in which the coolant may pass through the surfaces of both sides of the PTC heating elements 34 preferably provides improved heating efficiency.

Preferably, when the PTC heater 30 having the above-described structure is suitably provided in the inside of the PTC heating device with the COD function for a fuel cell vehicle, it is possible to prevent overload of the surface of the PTC heater 30. Accordingly, with the suitably large internal surface, the PTC heater 30 can provide sufficient heat transfer and high heating efficiency, thus preventing bubbles from forming inside the heater.

In preferred embodiments, a control system of the PTC heating device with the COD function for a fuel cell vehicle in accordance with the present invention may be suitably configured to obtain a more linear heating current value by a pulse width modulation control preferably based on the time interval and the period of a pulse, differently from a conventional power relay control according to on/off of a relay.

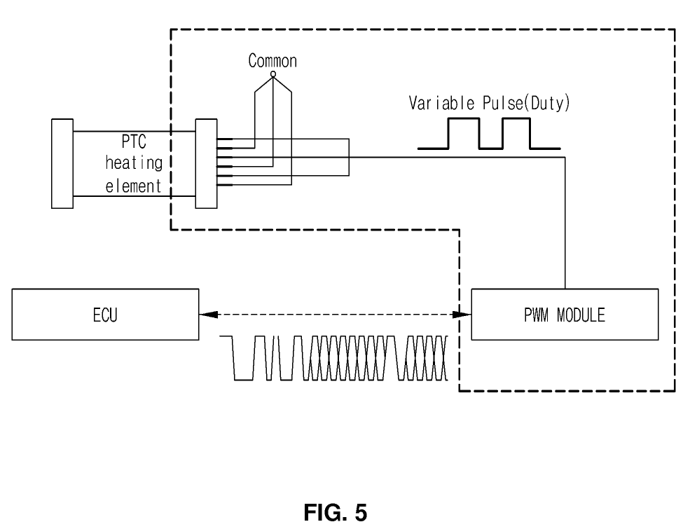

FIG. 5 shows an exemplary configuration of the PWM control system in which a waveform with various pulse widths is suitably applied from an electronic control unit (ECU) to the PTC heating element 34 through a PWM module so that the PTC heating element 34 generates heat. In exemplary embodiments, for the PWM control, the PWM module may be suitably provided on the top of a power source applying current to the PTC heating device with the COD function for a fuel cell vehicle in accordance with the present invention, and in further embodiments, the PWM module may be suitably located at an appropriate position for the convenience of configuration.

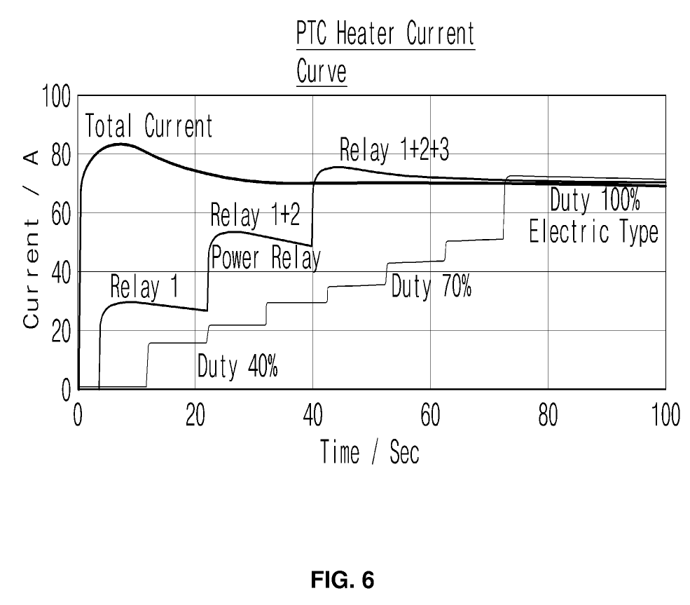

As shown in exemplary FIG. 6, it can be seen that the PWM control system can perform pulse-width modulation by preferably varying the duty ratio, compared with the conventional power relay control. Accordingly, since the surface temperature can be suitably controlled by applying a linear heating current value, it is possible to easily control the rising temperature of the fuel cell coolant and suitably maintain the target temperature.

As described herein, the PTC heating device with the cathode oxygen depletion function for a fuel cell vehicle in accordance with the present invention can provide the following effects.

The PTC heater can prevent overload of the heater surface due to a sudden increase in resistance even in the event that the coolant is not circulated due to a malfunction of a coolant pump, and suitably maintain the surface temperature constant.

With the use of the PTC heater in which the PTC heating elements are preferably arranged in a wide area on the radiating fin, the heating surface area is suitably increased to improve the heat transfer performance and prevent bubbles from forming.

With the PWM control performed instead of the conventional power relay control in the form of a cartridge, it is possible to obtain a more linear heating current value, and thus it is possible to easily control the rising temperature of the fuel cell coolant.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A PTC heating device with a cathode oxygen depletion function for a fuel cell vehicle, the PTC heating device comprising:
a housing including an inlet and an outlet, formed on both ends there of; and
a PTC heater fixed in the inside of the housing and including an electrode to which electric power is applied from the outside, a PTC heating element disposed on the electrode, and an insulating tape for insulating the PTC heater from a coolant flowing in the housing.

2. The PTC heating device of claim 1, wherein the PTC heater comprises at least one radiating plate including a plurality of radiating fins having concave and convex.

3. The PTC heating device of claim 1, wherein the PTC heating element included in the PTC heater is inserted between two electrodes and the insulating tape is arranged on the surfaces of both sides of the electrodes.

4. The PTC heating device of claim 1, wherein a PWM control system is provided on the outside of the housing to control a heating current.

5. The PTC heating device of claim 1, wherein the housing has a hexagonal cross section in which the width of the cross-sectional area is increased from the inlet to the middle portion, the width of the cross-sectional area is maintained constant in the middle portion, and the width of the cross-sectional area is reduced form the middle portion to the outlet.

6. The PTC heating device of claim 1, wherein a pair of guide plates is provided at the inlet in the housing to extend toward the inside of the housing.

7. A PTC heating device with a cathode oxygen depletion function for a fuel cell vehicle, the PTC heating device comprising:
a housing including an inlet and an outlet, formed on both ends there of; and
a PTC heater fixed in the inside of the housing.

8. The PTC heating device of claim 7, wherein the PTC heater fixed in the inside of the housing further includes an electrode to which electric power is applied from the outside and a PTC heating element disposed on the electrode.

9. The PTC heating device of claim 8, wherein the PTC heater fixed in the inside of the housing further includes an insulating tape for insulating the PTC heater from a coolant flowing in the housing.

10. The PTC heating device of claim 7, wherein the PTC heater comprises at least one radiating plate including a plurality of radiating fins having concave and convex surfaces.

11. The PTC heating device of claim 9, wherein the PTC heating element included in the PTC heater is inserted between two electrodes and the insulating tape is arranged on the surfaces of both sides of the electrodes.

12. The PTC heating device of claim 7, wherein a PWM control system is provided on the outside of the housing to control a heating current.

13. The PTC heating device of claim 2, wherein the housing has a hexagonal cross section in which the width of the cross-sectional area is increased from the inlet to the middle portion, the width of the cross-sectional area is maintained constant in the middle portion, and the width of the cross-sectional area is reduced form the middle portion to the outlet.

14. The PTC heating device of claim 3, wherein the housing has a hexagonal cross section in which the width of the cross-sectional area is increased from the inlet to the middle portion, the width of the cross-sectional area is maintained constant in the middle portion, and the width of the cross-sectional area is reduced form the middle portion to the outlet.

15. The PTC heating device of claim 4, wherein the housing has a hexagonal cross section in which the width of the cross-sectional area is increased from the inlet to the middle portion, the width of the cross-sectional area is maintained constant in the middle portion, and the width of the cross-sectional area is reduced form the middle portion to the outlet.

16. The PTC heating device of claim 2, wherein the housing has a hexagonal cross section in which the width of the cross-sectional area is increased from the inlet to the middle portion, the width of the cross-sectional area is maintained constant in the middle portion, and the width of the cross-sectional area is reduced form the middle portion to the outlet.

17. The PTC heating device of claim 3 wherein the housing has a hexagonal cross section in which the width of the cross-sectional area is increased from the inlet to the middle portion, the width of the cross-sectional area is maintained constant in the middle portion, and the width of the cross-sectional area is reduced form the middle portion to the outlet.

18. The PTC heating device of claim 4 wherein the housing has a hexagonal cross section in which the width of the cross-sectional area is increased from the inlet to the middle portion, the width of the cross-sectional area is maintained constant in the middle portion, and the width of the cross-sectional area is reduced form the middle portion to the outlet.
